(19) United States
(12) Patent Application Publication
(10) Pub. No.: US 2011/0293213 A1
(43) Pub. Date: Dec. 1, 2011

(54) IMPACT-RESISTANT ANGULAR BALL BEARING

(75) Inventors: Frank EICHELMANN, Hassfurt (DE); Ralf HEISS, Schweinfurt (DE); Arno WEHR-ALBERT, Dingolshausen (DE)

(73) Assignee: SCHAEFFLER TECHNOLOGIES GMBH & CO. KG

(21) Appl. No.: 13/117,665

(22) Filed: May 27, 2011

(30) Foreign Application Priority Data
May 27, 2010 (DE) 10 2010 021 813.8

(51) Int. Cl. F16C 33/58

(52) U.S. Cl. 384/569

(57) ABSTRACT

An angular ball bearing, in particular wheel bearing, with at least two rows of load-bearing rolling bodies and a hollow-cylindrical section arranged between two rolling body inner raceways. Inner rims are arranged at transitions from the hollow-cylindrical section to the rolling body inner raceways. The ball bearing is impactproof. This is achieved in that an annular element is arranged in, for example pressed into, the hollow-cylindrical section, axial force is transmitted between the rolling bodies of adjacent rows of rolling bodies, and a Brinelling of the raceway outlets and of the raceways is reduced or even prevented. The annular element may be an independent component or an annular element which is integrated in the outer ring, for which instructions regarding the required conditions are provided.

### CROSS-REFERENCE TO RELATED APPLICATION

This application claims the priority of DE 10 2010 021 813.8 filed May 27, 2010, which is incorporated by reference herein.

### FIELD OF THE INVENTION

The invention relates to an angular ball bearing, in particular wheel bearing.

### BACKGROUND OF THE INVENTION

Angular ball bearings are used in various constellations, for example as wheel bearings in vehicles. Angular ball bearings have to be able to absorb impact penetration loadings of the components mounted via the balls. If the impacts are too violent, the generally harder rolling bodies cause damage to the less hard rolling body raceways, this being referred to as Brinelling. The depth of impression of said damage is also called the Brinelling depth. If the Brinelling depth of the damage in the raceways is of an excessive size, a noise arises in the engine or in the vehicle during operation of the angular ball bearing.

The severity of the impact depends on the use. For example, what are referred to as mountings of the curb are the main cause of Brinelling in a wheel bearing. One possibility of reducing Brinelling can be achieved with various methods, but is generally sought in an increase in the raceway hardness. However, this measure does not suffice to reduce the Brinelling depth to an acceptable amount in wheel bearings from the prior art. Said wheel bearings typically have a raceway hardness of 750±70 HV10, wherein use is customarily made of rolling bearing steel of the type C56E2 or 100CR6.

U.S. Pat. No. 7,104,695 B2 discloses an asymmetric wheel bearing unit. In order to stiffen the wheel bearing unit, it is proposed to use two rows of rolling bodies with different pitch circle radii of the rows of rolling bodies. The row of rolling bodies on the wheel side has a greater pitch circle diameter than the row on the vehicle side. It is also taught to use different rolling body shapes for stiffening purposes. Said “hybrid wheel bearings” then have, for example, one row of rolling bodies having tapered rollers and a further row of rolling bodies having balls. The desired additional rigidity is produced on the basis of the increased supporting base and the different variation in the force-transmitting contact surfaces. With the rigidity, the impact strength of the angular ball bearing is likewise improved. Sudden tilting of the wheel hub with respect to the outer ring can therefore be better cushioned by the abovementioned measures.

However, an asymmetrical angular ball bearing unit requires an increased outlay on manufacturing, since rolling body raceways have to be provided with different radii and produced in a plurality of steps. Furthermore, the use of different rolling body shapes leads to a greater number of components, which likewise causes not inconsiderable costs.

### SUMMARY OF THE INVENTION

It is therefore the object of the invention to develop an angular ball bearing in such a manner that the impact insensitivity is improved cost-effectively.

The object is achieved by a wheel bearing unit with at least two rows of load-bearing rolling bodies, a hollow-cylindrical section arranged between two rolling body inner raceways, and raceway outlets arranged at transitions from the hollow-cylindrical section to the rolling body inner raceways where an annular element is arranged in the hollow-cylindrical section.

The invention is based on the finding that, in the event of the angular ball bearing components which are mounted on one another tilting axially, a dynamic impact between the rows of rolling body is passed on via the inner rim and is conducted in particular via the raceway outlets of the inner rim. Since the rolling bodies generally have harder material than the raceway outlets, this leads to plastic deformation of the raceway outlets and therefore to the Brinelling already mentioned. The annular element which is arranged in the hollow-cylindrical section is now used to transmit the force of the impact axially from one row of rolling bodies to the adjacent row of rolling bodies without the raceway outlets being detrimentally affected.

The axial width of the annular element is advantageously dimensioned in such a manner that an axial force can be transmitted between the rolling bodies of adjacent rows of rolling bodies and, in the process, the raceway outlets are protected from plastic deformation. For this purpose, the annular element can be machined prior to being arranged within the hollow-cylindrical section in such a manner that said annular element is optimally suitable for transmitting force between the rolling bodies of adjacent rows of rolling bodies. The raceway outlets are therefore relieved from load and the axial force which occurs in an impact is at least partially or entirely conducted via the annular element. The annular element can be adapted, for example, by means of a particular material, a particular shape or by the axial or radial size thereof in such a manner that an optimum diversion of force is produced for the angular ball bearing.

The annular element is advantageously through-hardened and is provided for the axial transmission of force between the rolling bodies of adjacent rows of rolling bodies. Through-hardening is understood as meaning a substantial approximation of the core hardness to the edge hardness. Since the annular element is a separate component, it is possible to harden said annular element, for example inductively, thermally or in another way, on all or at least some surfaces prior to the annular element being arranged within the hollow-cylindrical section. The degree of hardness within the annular element can therefore be raised very considerably, in particular by means of radially inner and radially outer hardening. Said access on both sides to the inner and outer surfaces of the annular element is not possible in the hardening process of the roller body inner raceways of an outer ring of an angular ball bearing of the prior art. Owing to very good through-hardening, the annular element is therefore particularly suitable for transmitting axial impact forces between the rows of rolling bodies. During the production of the angular ball bearing, the annular element can be arranged in the hollow-cylindrical section, for example by being pressed into the latter.

In an advantageous embodiment, the annular element continues an osculation of the respective raceway outlet on at least one axial annular surface. In principle, it is not necessary for the entire axial spacing between the rolling bodies of adjacent rows of rolling bodies to be taken up. In a low cost version of the angular ball bearing, in particular wheel bearing, it is sufficient if the axial width of the annular element only approximately fills the spacing of the rolling body inner raceways. In this case, a certain elastic deformation is accepted during the operation of the raceway outlets, but said deformation is supported to a specifiable deformation depth by the annular element. Therefore, a limit, as it were, is determined up to which deformation of the raceway outlets is intended to be permitted, that is to say, a certain elastic deformation is tolerated in favor of a more cost-effective angular ball bearing which is obtained in this case with an annular element which is easy to manufacture—and is therefore cost-effective.

As an alternative, the axial end surfaces of the annular element can continue the osculation of the rolling body inner raceways in order to permit as little axial play as possible between the rolling bodies and the annular element. This gives rise to highly effective protection which has an advantageous effect on the surface life of the angular ball bearing. The protection is better the smaller the inner radius of the annular element is in comparison to the pitch circle radius of the rolling body raceways. It is also conceivable for a plurality of rings to be arranged within the hollow-cylindrical section such that one ring accommodates a next smaller ring therewithin. With the multiplicity of rings, it is possible to create an arrangement which is very hard in the radial direction and which, owing to the multiplicity of rings, forms two large axial side surfaces which can be used for the axial transmission of an impact force. Furthermore, each ring can be hardened separately, giving rise overall to a very high core hardness of the multi-part, force-transmitting element.

In an advantageous embodiment, the osculation of the annular element in comparison to the inner rim having the raceway outlet is fixed to 1.03 to 1.05 (quotient between radii). A higher osculation reduces the axial play further, and therefore Brinelling is even better prevented by the through-hardened force-conducting means which is provided with minimum play and is in the form of the annular element.

In an advantageous embodiment, the hollow-cylindrical section is formed by one, two or more outer rings. It is important in this case for the annular element to be able to be received within the hollow-cylindrical section. This gives rise to a certain simplicity for the angular ball bearing which therefore has a lower degree of integration (large number of components) but does not have to dispense with an annular element conducting axial force.

In an advantageous embodiment, the annular element has an inner radius RR which is smaller than the total of the pitch circle radius TKR of one of the rows of rolling bodies and one third of the rolling body radius WR. For the axial transmission of force, an arrangement of the annular element on the radius of the rolling body center point is best, but gives rise to a new problem during the assembly of the angular ball bearing. The annular element has to have a certain radial thickness for stability reasons. It is therefore advantageous to provide an inner radius which is up to one third of the rolling body radius smaller than the pitch circle radius TKR. Therefore, an optimum axial transmission of force is ensured and so too is simple installation of the wheel bearing, wherein the following applies:

TKR−⅓WR<RR<TKR+⅓WR

If the inner radius RR exceeds the pitch circle radius TKR by more than WR/3, then the axial further conducting means cannot transmit the impact force directly in the direction of the ball centers but rather additionally obtains an excessively sized radial component which, in turn, promotes elastic deformation of the raceway outlets. For installation reasons, the inner radius RR of the annular element is selected to be greater than TKR−⅓ WR.

In an advantageous embodiment, the following applies in particular:

TKR−⅕WR<RR<TKR+⅕WR

wherein the capability of axial transmission of force via the annular element is not reduced despite a simpler installation.

In an advantageous embodiment, the annular element has a radial thickness of at least one-tenth of the rolling body radius. Owing to the annular form of the annular element, the axial transmission of force is influenced positively simply by the annular element being structurally rigid. Elastic deformation of the annular element in radial directions or even breakage because of the diversion of force in the radial direction can additionally be countered by an appropriately enlarged radial thickness of the annular element which should advantageously be greater than 1/10 of the rolling body radius but at least greater than one-twelfth of the rolling body radius, since otherwise breaking of the annular element becomes ever more likely. A thickness of ⅖ of the rolling bearing radius WR or even ⅔ of the rolling bearing radius WR is suitable as the upper limit.

In an advantageous embodiment, the annular element is formed integrally with the outer ring which at least partially forms the hollow-cylindrical section. With an angular ball bearing unit substantially integrated, the hollow-cylindrical section can be formed by an outer ring which is possibly still formed integrally with a fastening flange or integrally with a wheel flange. Nevertheless, it may be advantageous, depending on the application, to insert a plurality of outer rings, and therefore the hollow-cylindrical section is formed by a plurality of outer rings and the annular element is also divided in the axial direction into a plurality of individual annular elements which are each integrated into an outer ring.

In the event of use of annular element which is formed integrally with a plurality of outer rings or with a single outer ring, the following conditions should be noted:

a) the annular element has a radial thickness of at least one-tenth of the rolling body radius.
b) the cylindrical annular element has an inner radius RR which is smaller than the total of the pitch circle radius TKR of one of the rows of rolling bodies and one-third of the rolling body radius WR; in this case, the pitch circle radius TKR is the radius of a circle about the axis of rotation R of the angular ball bearing, which radius is formed by the rolling body center points.
c) the rolling body raceways have an osculation of between 1.03 and 1.05 (quotient between radii) on the cylindrical annular element formed integrally with the outer ring, wherein the rolling body raceway is partially formed by the annular element, and
d) the cylindrical annular element which is formed integrally with the outer ring has a hardness of at least 800±40 HV.

In an advantageous embodiment, the raceway outlets each form rim angles of between 70° and 86°, wherein the rim angle is defined between two limbs, and the first limb is arranged collinearly with the vertical (radial) of the bearing and the second limb is formed from a straight line from the center point of the rolling body as far as the closest edge of the hollow-cylindrical section. The two limbs enclose the rim angle.

A further advantage is afforded if the rolling bodies have a greater hardness than the raceway outlets of the rolling body raceway and the annular element. This ensures that damage occurs to the raceway and not to the rolling body, which would cause serious damage.

Further advantageous embodiments and preferred developments of the invention can be gathered from the description of the figures and/or the dependent claims.

### BRIEF DESCRIPTION OF THE DRAWINGS

The invention is described and explained in more detail below with reference to the exemplary embodiments which are illustrated in the figures, in which:

FIG. 1 shows a sectioned view of a first two-row wheel bearing with a cylindrical annular element,

FIG. 2 shows an enlarged view of the wheel bearing from FIG. 1,

FIG. 3 shows a sectioned view of the cylindrical annular element from FIGS. 1 and 2,

FIG. 4 shows a sectioned view of a second two-row wheel bearing with an integrated annular element,

FIG. 5 shows an enlarged view of the wheel bearing from FIG. 4 with the cylindrical annular element emphasized,

FIG. 6 shows an enlarged view of the wheel bearing from FIG. 4 with the hardened region on the outer ring emphasized,

FIG. 7 shows an enlarged view of the wheel bearing from FIG. 4 with emphasis on the osculation properties, and

FIG. 8 shows, for illustrative purposes, the relationship between a number of wheel bearing sizes.

### DETAILED DESCRIPTION OF THE INVENTION

FIG. 1 shows a sectioned view of a first two-row wheel bearing with a cylindrical annular element 5. The two-row wheel bearing shown is particularly protected against what are referred to as mountings of the curb. In the event of mounting of a curb, the vehicle drives or slides with the tire against a curb or against a similar obstacle. In the process, an axial force and a moment, which are associated with tilting of the components mounted with respect to one another, are introduced into the bearing. If the pulse is of a sufficient strength, rolling bodies, here a ball, is pressed plastically into the raceway and leaves behind an impression (Brinelling). At a Brinelling depth of more than 3 μm, a noise may be produced in the vehicle during driving.

The two-row wheel bearing has a wheel-side raceway outlet 13 and a vehicle-side raceway outlet 14 of the outer ring 1, wherein the raceway outlets 13, 14 are connected to each other by a hollow-cylindrical section 4 (inner rim). The raceway outlets 13, 14 form an end-side part of the rolling body inner raceways of the outer ring 1.

Furthermore, the wheel bearing has the customary structural elements, for example a rolling bearing cage 6 which contains the rolling bodies 3. The outer ring 1 is sealed off in axial directions from the rotating wheel hub 2 and the inner ring 8 by means of sealing arrangements 7, and therefore the rolling space in which the rolling bodies 3 are located is protected from environmental influences. On the vehicle side, the sealing arrangement is designed as a cassette seal 7.

According to the invention, the hollow-cylindrical section 4 contains a cylindrical annular element 5 which is pressed into the latter and is not in contact with any of the rolling bearings 3 during operation of the wheel bearing. If axial forces occur, in which at least some of the rolling bearings 3 of one of the two rows of rolling bearings move towards the other row in each case, then the annular element 5 acts as an axial securing means preventing a decrease below a minimum rolling body spacing if the axial rolling body spacing is reduced. Said minimum rolling body spacing is defined by the axial width of the cylindrical annular element 5. In this case, a certain level of damage to one of the two raceway outlets 13, 14 is accepted, but the depth of penetration is limited by the cylindrical annular element 5. More serious damage can therefore be averted, and therefore vehicle noises are also avoided and the surface life of the wheel bearing is extended.

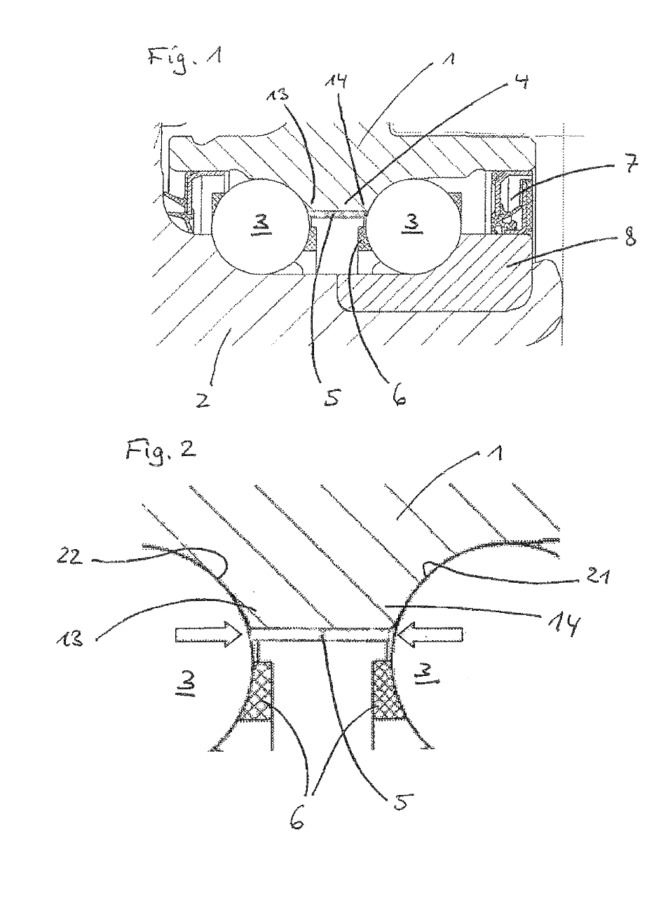

FIG. 2 shows an enlarged view of the wheel bearing from FIG. 1. The two depicted arrows indicate the direction of the axial force during mounting of a curb, which force can emerge both from the vehicle-side row of rolling bodies and from the wheel-side row of rolling bodies. During normal operation, the cylindrical annular element 5 is spaced apart on both sides from the rolling bodies but, depending on the force to be transmitted, a slight displacement of the annular element 5 in an axial direction may occur, and therefore displacement relative to the outer ring 1 also takes place. Such a displacement can be tolerated only to a limited extent since the raceway outlets 13, 14 are detrimentally affected in this case. It is therefore more advantageous if the annular element 5 is secured in a form-fitting manner on the outer ring 1, but is at least pressed into the latter.

As an alternative, the annular element 5 can continue one of the two rolling body inner raceways 21, 22 or else both raceways, radially inwards (towards the axis of rotation R), by a similar or identical osculation as that of the rolling body inner raceways 21, 22 being formed on the axial end surfaces of the annular element 5. Care should be taken in this solution to ensure that the axial spacing from the rolling bodies 3 is as small as possible.

Furthermore, care should be taken to ensure that the cage 6 is not obstructed by the annular element 5 and that contacts between the two components are avoided.

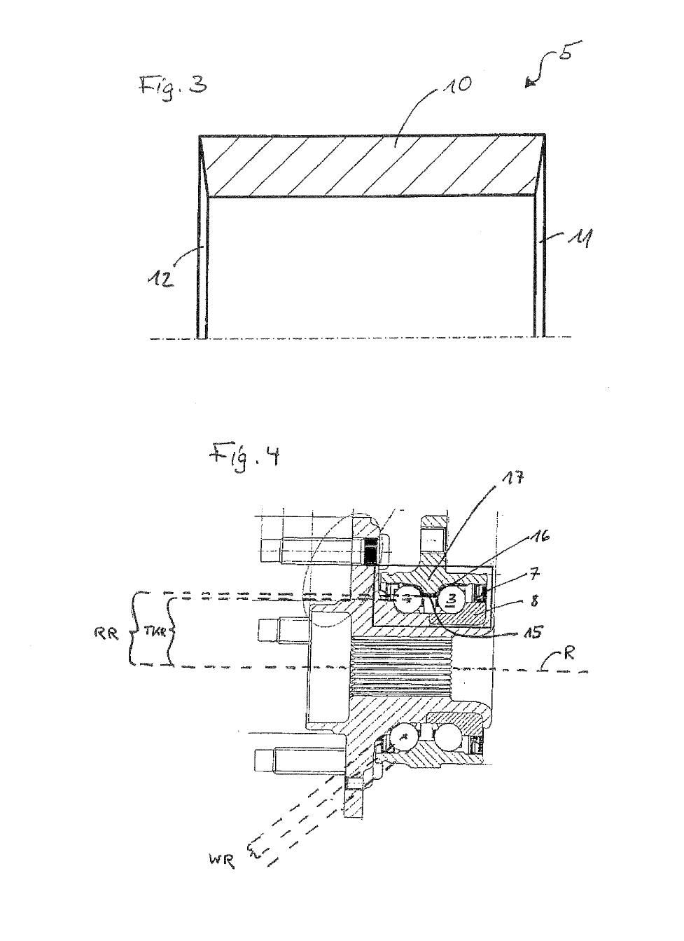

FIG. 3 shows a sectioned view of the cylindrical annular element 5 from FIGS. 1 and 2. The edges of the sectional surface 10 of the cylindrical annular element 5 (illustrated in section form) shows that the axial side surfaces 11, 12 form a tapered section, which means that the annular element 5 is used as a minimum spacer. Low cost versions of a wheel bearing can therefore be realized by the spacing from the rolling bodies being selected to be as far as possible of equal size on both sides and the annular element 5 not forming rolling body inner raceways.

As an alternative, the axial side surfaces 11, 12 can form a segment of a hollow ball, the radius of which is determined by the rolling body radius WK and the osculation. In this case, the cylindrical annular element 5 continues the rolling body inner raceways 21, 22 radially, as can be seen in FIG. 2, and therefore axial securing of the annular element 5 is no longer required since the annular element 5 cannot move axially either toward the vehicle-side row of rolling bodies or towards the wheel-side row of rolling bodies.

FIG. 4 shows a sectioned view of a second two-row wheel bearing with an integrated annular element 15 and bearing sizes shown.

The second wheel bearing has an outer ring 17 which has both an integrated fastening flange and an annular element 16 integrated integrally with the outer ring 17. When an annular element 16 is integrated integrally with the outer ring 17, care should be taken to ensure that at least three conditions are met, namely an increase in the edge layer hardness, a sharp osculation of the rolling body raceways and as small as possible an inner radius RR of the cylindrical annular element 15.

In this alternative solution, the raceway outlets are enlarged as it were in the radial direction, thereby causing separation of the rolling bodies. However, this alone still does not bring about sufficient protection against mounting of curbs. Furthermore, a higher edge layer hardness is required which also leads to the desired outcome only in combination with a narrowing of the oscillations. It should be noted in this connection that the effective force transmission surface is much larger in the event of a radial force than in the event of an axial force because it is not possible to fully surround the rolling bodies. An axial force which is comparable in magnitude will therefore always lead to a greater force density on the rolling body inner raceways. The omission of just one of the three measures mentioned results in an axial transmission of forces between the rolling bodies 3 of adjacent rows of rolling bodies, said transmission being harmful for the bearing.

In some use examples, for example with an easier installation option, the inner radius of the integrated annular element 5 is larger than the pitch circle radius of the rows of rolling bodies. However, it is expedient for both radii to approximate each other as far as possible. It is advantageous if the inner radius RR does not exceed the total of the pitch circle radius TKR plus one-tenth of the rolling body radius WR. The pitch circle radius TKR and the inner radius RR are perpendicular to the axis of rotation of the wheel bearing.

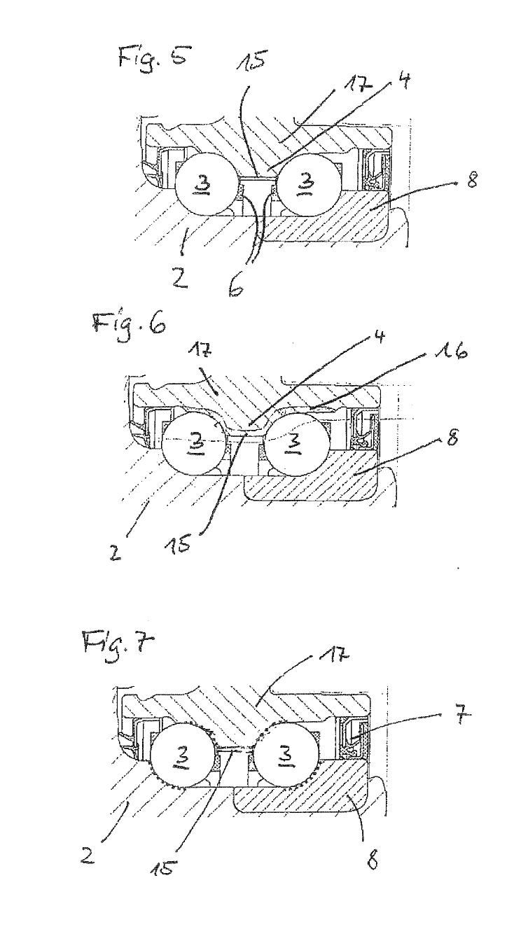

FIG. 5 shows an enlarged view of the wheel bearing from FIG. 4 with the integrated annular element 15 emphasized. One advantage of an integrated annular element 15 is the fact that the outer ring 17 can be manufactured together with the annular element 15, with the annular element 15 being hardened to a particular degree, for example inductively, as penetratively as possible in the radial direction. In this case, a core hardness of the annular element 15 of at least 800±40 HV should be obtained.

FIG. 6 shows an enlarged view of the wheel bearing from FIG. 4 with the hardened region on the outer ring 17 emphasized. The integrated annular element 15 is advantageously hardened in the same cycle as the rolling body inner raceways of the outer ring 17 such that there is scarcely any additional outlay.

FIG. 7 shows an enlarged view of the wheel bearing from FIG. 4 with emphasis on the particular osculation of the rolling body raceways. The dots shown in FIG. 7 show the regions of increased osculation which is between 1.03 and 1.05 (quotient between radii).

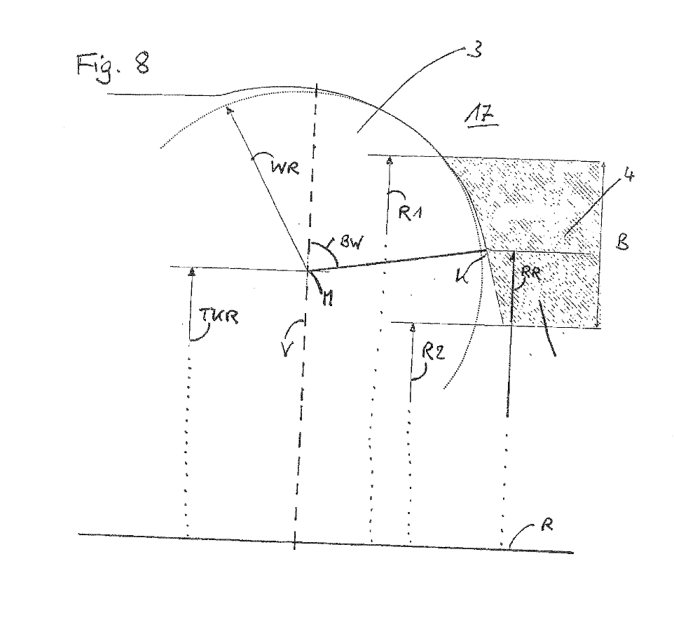

FIG. 8 shows, for illustrative purposes, the relationship between a number of wheel bearing sizes.

The inner radius RR of the inner surface of the annular element 15, which, in FIG. 8, is formed integrally with the outer ring 17, lies between the radii R1 and R2, wherein R1=TKR+⅓WR and R2=TKR−⅓ WR. In this case, TKR stands for the pitch circle radius of the row of rolling bodies with reference to the axis of rotation R of the wheel bearing. WR is the radius of the rolling bodies 3. The inner surface of the hollow-cylindrical section 4 can therefore be arranged in a radial region B, with it being possible for the rim angle to be correspondingly changed.

The rim angle BW is enclosed by the vertical V of the wheel bearing and the section between the center point M of the rolling body 3 to the edge K of the annular element. The rim angle is ideally between 70 and 86 degrees. As can be gathered from FIG. 8, said rim angle may also be 90 degrees or more.

In summary, the invention relates to an angular ball bearing, in particular wheel bearing, with at least two rows of load-bearing rolling bodies (3) and with a hollow-cylindrical section (4) arranged between two rolling body inner raceways (21, 22), wherein respective inner rims (13, 14) are arranged at transitions from the hollow-cylindrical section (4) to the rolling body inner raceways (21, 22). It is the declared aim to provide a particularly impactproof angular ball bearing. This is achieved in that an annular element (5, 15) is arranged in, for example pressed into, the hollow-cylindrical section (4), with which axial force is transmitted between the rolling bodies (3) of adjacent rows of rolling bodies, and a Brinelling of the raceway outlets (13, 14) and of the raceways (21, 22) is reduced or even prevented. The annular element (5) may be designed as an independent component but may also be designed as an annular element (15) which is integrated in the outer ring, for which instructions regarding the required conditions are provided.

List of Designations

| | | | |
|---|---|---|---|
| 1 | Outer Ring | 2 | Wheel Hub |
| 3 | Rolling Body | 4 | Hollow-Cylindrical Section |
| 5 | Cylindrical Annular Element | 6 | Cage |
| 7 | Cassette Seal | 8 | Inner Ring |
| 10 | Sectional Surface | 11 | Axial Side Surface |
| 12 | Axial Side Surface | 13 | Wheel-Side Raceway Outlet |
| 14 | Vehicle-Side Raceway Outlet | 15 | Integrated Annular Element |
| 16 | Hardened Region | 17 | Outer Ring |
| 21 | Inner Raceway | 22 | Inner Raceway |
| 25 | Annular Element | B | Radial Region |
| TK | Pitch Circle Radius | RR | Inner Radius of the Annular |
| | | | Element |
| R | Axis of Rotation | WR | Rolling Body Radius |
| R1 | Maximum Radius | R2 | Minimum Radius |
| K | Edge | M | Center Point |

1-11. (canceled)

12. An angular ball bearing comprising:
an outer ring having at least two, axially spaced, inner raceways;
at least two, axially spaced, outer raceways which radially oppose the inner raceways;
at least two rows of axially spaced load bearing rolling bodies radially between the inner and outer raceways;
a cylindrical space axially between the two inner raceways, the space radially inside the outer rim and radially abutting the outer rim; and
an annular element positioned in the cylindrical space.

13. The angular ball bearing according to claim 12, wherein the angular ball bearing is a wheel bearing.

14. The angular ball bearing according to claim 12, wherein the annular element is through-hardened and transmits an axial force between the rolling bodies of adjacent rows of the rolling bodies.

15. The angular ball bearing according to claim 12, wherein the annular element continues respective raceway outlet.

16. The angular ball bearing according to claim 15, wherein the annular element has a radius between 1.03 and 1.05 greater than a radius of the raceways.

17. The angular ball bearing according to claim 12, wherein the annular element has an axial width such that an axial force can be transmitted between the rolling bodies of adjacent rows of rolling bodies so as to protect the inner raceway outlets from plastic deformation.

18. The angular ball bearing according to claim 12, wherein the hollow-cylindrical section is formed by one, two or more outer rings.

19. The angular ball bearing according to claim 12, wherein the annular element has an inner radius, which is smaller than a total of a pitch circle radius of one of the rows of rolling bodies and one third of a rolling body radius.

20. The angular ball bearing according to claim 19, wherein the annular element has a radial thickness of at least one-tenth or at least one-fifth of the rolling body radius.

21. The angular ball bearing according to claim 12, wherein the annular element is formed integrally with the outer ring, which at least partially forms the hollow-cylindrical section, and wherein the annular element has a radial thickness of at least one-tenth or at least one-fifth of the rolling body radius, the annular element has an inner radius which is smaller than a total of a pitch circle radius of one of the rows of rolling bodies and one third of a rolling body radius, and the radius of the rolling body raceways have an osculation of between 1.03 and 1.05 by means of the radius of the annular element, and the annular element has a hardness of at least 800±40 HV.

22. The angular ball bearing according to claim 20, wherein raceway outlets on the hollow-cylindrical section each form a rim angle of between 70 and 86 degrees.

23. The angular ball bearing according to claim 12 wherein the annular element is separate from the outer ring
